(19) United States
(12) Patent Application Publication
(10) Pub. No.: US 2011/0137898 A1
(43) Pub. Date: Jun. 9, 2011

(54) UNSTRUCTURED DOCUMENT CLASSIFICATION

(75) Inventors: Albert Gordo, Barcelona (ES); Florent Perronnin, Domene (FR); Francois Ragnet, Venon (FR)

(73) Assignee: XEROX CORPORATION, Norwalk, CT (US)

(21) Appl. No.: 12/632,135

(22) Filed: Dec. 7, 2009

(51) Int. Cl. G06F 17/30

(52) U.S. Cl. 707/737; 707/E17.089

(57) ABSTRACT

A document classification method comprises: (i) classifying pages of an input document to generate page classifications; (ii) aggregating the page classifications to generate an input document representation, the aggregating not being based on ordering of the pages; and (iii) classifying the input document based on the input document representation. A page classifier for use in the page classifying operation (i) is trained based on pages of a set of labeled training documents having document classification labels. In some such embodiments, the pages of the set of labeled training documents are not labeled, and the page classifier training comprises: clustering pages of the set of labeled training documents to generate page clusters; and generating the page classifier based on the page clusters.

### BACKGROUND

The following relates to the classification arts, document processing arts, document routing arts, and related arts.

A document typically comprises a plurality of pages. For electronic document processing, these pages are generated in or converted to an electronic format. An example of an electronically generated document is a Word processing document that is converted to portable document format (PDF). An example of a converted document is a paper document whose pages are scanned by an optical scanner to generate electronic copies of the pages in PDF format, an image format such as JPEG, or so forth. An electronic document page can be variously represented, for example as a page image, or as a page image with embedded text. In the case of an optically scanned document, a page image is generated, and embedded text may optionally be added by optical character recognition (OCR) processing.

In general, the pages of a document may have ordered pages (e.g., enumerated by page numbers and/or stored in a predetermined page sequence) or may have unordered pages. An example of a document that typically has unordered pages is an unbound file that is converted into an electronic document by optical scanning. In such a case, the unbound pages are not in any particular order, and are scanned in no particular order. Some examples of unbound files include: an employee file containing loose forms completed by the employee, the employee's supervisor, human resources personnel, or so forth; an application file containing an application form and various supporting materials such as a copy of a driver's license or other identification, one or more recommendation letters, a completed applicant interview record form, or so forth; a medical patient file containing materials such as consent forms completed by the patient, completed emergency contact information forms, patient medical records; a correspondence, containing a letter expressing the customer's intent, a filled out form to request a change of address, a driver's license or other identification, and a utility bill proving the new address; or so forth.

The following discloses methods and apparatuses for classifying documents without reference to page order.

### BRIEF DESCRIPTION

In some illustrative embodiments disclosed as illustrative examples herein, a method comprises: (i) classifying pages of an input document to generate page classifications; (ii) aggregating the page classifications to generate an input document representation, the aggregating not being based on ordering of the pages; and (iii) classifying the input document based on the input document representation. These operations are suitably performed by a digital processor.

In some illustrative embodiments disclosed as illustrative examples herein, the method of the immediately preceding paragraph further comprises: training a page classifier for use in the page classifying operation (i) based on pages of a set of labeled training documents having document classification labels. In some such embodiments, the pages of the set of labeled training documents are not labeled, and the page classifier training comprises: clustering pages of the set of labeled training documents to generate page clusters; and generating the page classifier based on the page clusters.

In some illustrative embodiments disclosed as illustrative examples herein, an apparatus comprises a digital processor configured to perform a method including classifying pages of an input document to generate page classification and aggregating the page classifications to generate an input document representation.

In some illustrative embodiments disclosed as illustrative examples herein, a storage medium stores instructions that are executable by a digital processor to perform method operations including: (i) classifying pages of an input document to generate page classification; and (ii) aggregating the page classifications to generate an input document representation, the aggregating not based on ordering of the pages in the input document.

In some illustrative embodiments disclosed as illustrative examples herein, the instructions stored on a storage medium as set forth in the immediately preceding paragraph are executable by a digital processor to perform method operations further including at least one of: retrieving a document similar to the input document from a database based on the input document representation; and clustering a collection of input documents by repeating the operations (i) and (ii) for each input document of the collection of input documents and performing clustering of the input document representations.

### BRIEF DESCRIPTION OF THE DRAWINGS

FIG. 1 diagrammatically shows an apparatus for performing document classification and for using the document classification in an application such as document routing or similar document retrieval.

FIG. 2 diagrammatically shows generation of an input document representation in the apparatus of FIG. 1.

FIG. 3 diagrammatically shows an extension of the apparatus of FIG. 1 to provide training for generating the trained page classifier module and trained document classifier module of FIG. 1.

FIG. 4 diagrammatically shows the page clustering operation performed by the training apparatus of FIG. 3.

FIGS. 5 and 6 show some experimental results.

### DETAILED DESCRIPTION

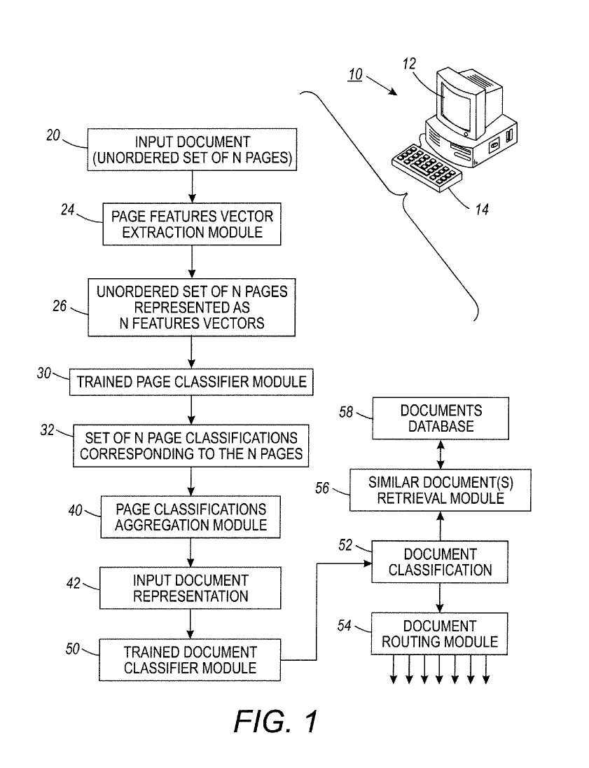

With reference to FIG. 1, an illustrative apparatus is embodied by a computer 10. The illustrative computer 10 includes user interfacing components, namely an illustrated display 12 and an illustrated keyboard 14. Other user interfacing components may be provided in addition or in the alternative, such as mouse, trackball, or other pointing device, a different output device such as a hardcopy printing device, or so forth. The computer 10 could alternatively be embodied by a network server or other digital processing device that includes a digital processor (not illustrated). The digital processor may be a single-core processor, a multi-core processor, a parallel arrangement of multiple cooperating processors, a graphical processing unit (GPU), a microcontroller, or so forth.

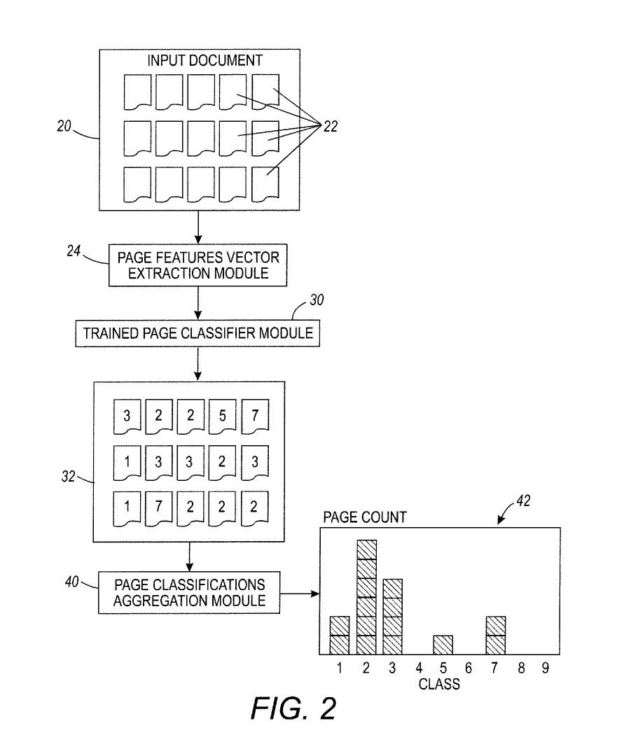

With continuing reference to FIG. 1 and with further reference to FIG. 2, the computer 10 or other digital processing device is configured to perform a document classification process applied to an input document 20. As diagrammatically shown in FIG. 2, the input document 20 comprises a set of pages 22, which are not in any particular order. Alternatively, the set of pages 22 may have some particular page ordering such as page numbering, but the page ordering information is not used by the processing performed by the apparatus of FIGS. 1 and 2. The pages 22 may be generated by optically scanning a hardcopy document, or may be generated electronically by a word processor or other application software running on the computer 10 or elsewhere. Without loss of generality, the number of pages of the input document 20 is denoted as N, where N is an integer having value greater than or equal to one.

A page features vector extraction module 24 generates a features vector to represent each page 22. In general, the components (that is, features) of the features vector can be visual features, text features, structural features, various combinations thereof, or so forth. An example of a visual feature is a runlength histogram, which is a histogram of the occurrences of runlengths, where a runlength is the number of successive pixels in a given direction in an image (e.g., a scanned page image) that belong to the same quantization interval. A bin of the runlength histogram may correspond to a single runlength value, or a bin of the runlength histogram may correspond to a contiguous range of runlength values. In the features vector, the runlength histogram may be treated as a single element of the features vector, or each bin of the runlength histogram may be treated as an element of the features vector.

Text features may include, for example, occurrences of particular words or word sequences such as “Application Form”, “Interview”, “Recommendation”, or so forth. For example, a bag-of-words representation can be used, where the entire bag-of-words representation is a single (e.g., vector or histogram) element of the features vector or, alternatively, each element of the bag-of-words representation is an element of the features vector. Text features are typically useful in the case of document pages that are electronically generated or that have been optically scanned followed by OCR processing so that the text of the page is available. Structural features may include, for example, the location, size, or other attributes of text blocks, a measure of page coverage (e.g., 0% indicating a blank page and increasing values indicating a higher fraction of the page being covered by text, drawings, or other markings).

In general, the features vector extracted from a given page 22 is intended to provide a set of quantitative values at least some of which are expected to be probative (possibly in combination with various other features) for classifying the input document 20. The output of the page features vector extraction module 24 is the unordered set of N pages 22 represented as an unordered set of N features vectors 26.

The pages 22 of the input document 20, as represented by the unordered set of N features vectors 26, are received by a trained page classifier module 30 which generates a page classification 32 for each page 22. The page classifications can take various forms. In some embodiments, the page classification assigns a page class to the page 22, where the page class is selected from a set of page classes. In some such embodiments, the classification is a hard page classification in which a given page is assigned to a single page class of the set of page classes. In some such embodiments, the classification employs soft page classification in which a given page is assigned probabilistic membership in one or more page classes of the set of page classes. In some embodiments, the page classifications retain features vector positional information in the features vector space, for example using a Fisher kernel.

In the diagrammatic example of FIG. 2, the trained page classifier module 30 employs hard classification using a set of classes enumerated “1” through “9”, and the page classifications 32 are diagrammatically shown in FIG. 2 by superimposing the page class numerical identification on each page. The set of page classes may include, for example: “handwritten letter”, “typed letter”, “form X” (where X denotes a form identification number or other form identification), “Personal identification” (for example, a copy of a driver's license, birth certificate, passport, or so forth), “phone bill”, or so forth. Again without loss of generality, the N pages 22 of the input document 20 are classified by the trained page classifier module 30 to generate corresponding N page classifications 32.

The page classifications 32 provide information about the individual pages 22, but do not directly classify the input document 20. The document classification approaches disclosed herein leverage recognition that a given document class is likely to contain a “typical” distribution of pages of certain types (i.e. page classes). For example, a job application file (i.e., input document) may be expected to have a “typical” page distribution including a few pages of the “typed letter” type (corresponding to recommendation letters), at least one page of “application form” type, a sheet of an “interview summary” type, and so forth. On the other hand, a “typical” page distribution for an employee file may have a relatively larger number of forms, fewer or no typed letters, and so forth.

On the other hand, any given page type may be present in documents of different types—for example, a page of page class “Personal identification” (e.g., a copy of a driver's license, passport, or so forth) may be present in documents of various types, such as in application files, employee files, medical files, or so forth. Still further, even if a document of a given type “must” contain a particular page type (for example, an application file might be required to include a completed application form), it is nonetheless possible that this page type may be missing in a particular file (for example, the completed application form may have been lost, not yet supplied by the applicant, or so forth). Accordingly, it is recognized herein that it is generally inadvisable to rely upon the presence or absence of pages of any single page type in classifying a document.

In view of the foregoing insights, the document classification process proceeds as follows. A page classifications aggregation module 40 aggregates the page classifications of the pages 22 of the input document 20 to generate an input document representation 42. The aggregation of page classifications performed by the module 40 is not based on ordering of the pages, since it is assumed that the document pages are not ordered in any particular order. In the case of hard page classifications, the aggregation may suitably entail counting the number of pages assigned to each page class of the set of page classes, and arranging the counts as elements of a histogram or vector whose bins or elements correspond to classes of the set of classes. In the case of soft page classification, a similar approach can be used except that the counting is replaced by summation over the set of pages of the class probability assigned to each page for a given class. Stated more generally, the page classifications provide statistics of the pages respective to the classes. For example: the statistics include class assignments in the case of hard classification; the statistics include class probabilities in the case of soft classification; the statistics include vector positional information (e.g., respective to class clustering centers in the features vector space) in the case of a page classification represented as a Fisher kernel; or so forth. The page classifications aggregation module 40 then aggregates the statistics of the pages 22 of the input document 20 for each page class to generate the input document representation 42. In any of these approaches, input document representation 42 may optionally be normalized. For example, in the example of hard classification and a histogram document representation employing counting, the values can be normalized by the total number of pages so that the histogram bin values or vector element values sum to unity.

In the illustrative example of FIG. 2, the page classifications aggregation module 40 generates the input document representation 42 as a histogram or vector whose elements correspond to page classes of the set of classes. In the diagrammatic example of FIG. 2, in which the page classifier module 30 employs hard classification respective to a set of nine classes identified by enumerators “1”, “2”, . . . , “9”, the input document representation 42 is illustrated as a histogram with bins “1”, “2”, . . . , “9” corresponding to the nine page classes of the illustrative set of page classes. In this illustrative embodiment employing hard page classification, the elements of the histogram or vector are computed as counts of pages of the input document 20 that are assigned to corresponding page classes of the set of classes. For instance, the page classifications 32 include two pages assigned to class “1”, and so bin “1” of the histogram input document representation has count=2. Similarly, six pages are assigned to class “2” and so bin “2” of the histogram has count=6; and so forth.

With continuing reference to FIG. 1, the input document representation 42 provides information about the distribution of page types in the input document 20, and hence is expected to be probative of the document type. Accordingly, a trained document classifier module 50 receives the input document representation 42 and outputs a document classification 52 determined from the input document representation 42. The trained document classifier module 50 can in general employ substantially any classification algorithm. The document classification 52 can take various forms, such as: hard classification assigning a single class for the input document 20 that is selected by the classifier module 50 from a set of classes; soft classification that assigns class probabilities to the input document 20 for the classes of the set of classes; or so forth. In some embodiments, the classifier module 50 employs a soft classification algorithm then assigns the input document 20 to the class having the highest class probability as determined by the soft classification.

The document classification 52 can be used in various ways. In some applications, the document classification 52 serves as a control input to a document routing module 54 which routes the input document 20 to a correct processing path (e.g., department, automated processing application program, or so forth). The routing may be purely electronic, that is, the scanned or otherwise-generated electronic version of the input document 20 is routed via a digital network, the Internet, or another electronic communication pathway to a computer, network server, or other digital processing device selected based on the document classification 52. Additionally or alternatively, the routing may entail physical transport of a hardcopy of the input document 20 (for example, physically embodied as a file folder containing printed pages) to a processing location (e.g., office, department, building, et cetera) selected based on the document classification 52.

In another illustrative application, a similar document(s) retrieval module 56 searches a documents database 58 for documents that are similar to the input document 20. In this application, it is assumed that the documents stored in the documents database have been previously processed by the classification system 24, 30, 40, 50 so as to generate corresponding document classifications that are stored in the database 58 together with the corresponding documents as labels, tags, or other metadata. Accordingly, the similar document(s) retrieval module 56 can compare the document classification 52 of the input document 20 with document classifications stored in the database 58 in order to identify one or more stored documents having the same or similar document classification values. Advantageously, this enables comparison and retrieval of documents without regard to any page ordering, and therefore is useful for retrieving similar documents having no page ordering and for retrieving similar documents that are similar in that they have similar pages but which may have a different page ordering from that of the input document 20 (which, again, may have no page ordering, or may have page ordering that is not used in the document classification processing performed by the system 24, 30, 40, 50). In a variant embodiment, the processing stops at the page classifications aggregation module 40, so that each input document is represented by its corresponding input document representation 42. The retrieval can then be performed based on searching for similar input document representations, rather than similar document classifications. In this variant embodiment, the trained document classifier module 50 is suitably omitted.

The applications 54, 56 are merely illustrative examples, and other applications such as document comparator applications, document clustering applications, and so forth can similarly utilize the document classification 52 generated for the input document 20 by the system 24, 30, 40, 50. In the case of document clustering applications, the clustering can again either cluster the document classifications 52 of the documents to be clustered, or can cluster the input document representations 42 of the documents to be clustered. If the input document representations are clustered, then the trained document classifier module 50 is again suitably omitted.

The effectiveness of the document classification system 24, 30, 40, 50 is dependent upon the trained page classifier module 30 generating probative page classifications 32, and is further dependent upon the trained document classifier module 50 generating an accurate document classification 52 based on the aggregated probative page classifications 32. Accordingly, the classifier modules 30, 50 should be trained on a suitably diverse training set of documents.

In some embodiments, the training set of documents is generated by manually labeling the training documents with document types and by further manually labeling each page of each document with a page type. In such embodiments, the page classifier module can be trained in a supervised training mode utilizing the manually supplied page classifications. The thusly trained page classifier module 30 and the aggregation module 40 is then applied to the pages of the training set to generate input document representations for the training documents, and the document classifier module is trained in a supervised training mode utilizing the manually supplied document classification labels. Alternatively, in the second operation the manually supplied page classifications can be directly input to the aggregation module 40 to generate the input document representations for the training documents that are then used to train the document classifier module.

The foregoing approach entails both (i) manually labeling the training documents with document classifications and (ii) manually labeling each page of each training document with a page classification. If, for example, there are 10,000 documents with an average of ten pages per document, this involves 110,000 manual classification operations.

The foregoing approach also employs both a set of page classes and a set of document classes. The user is likely to have a set of document classes already chosen, since the purpose of the document classification is to classify documents. By way of example, in the document routing application the user is likely to identify one document class for to each possible document route, and so the set of document classes is effectively defined by the document routing module 54. However, the user may not have a readily available or pre-defined set of page classes for use in manually labeling the pages of the training documents. The page classifications are intermediate information used in the document classification process, and are not of direct interest to the user.

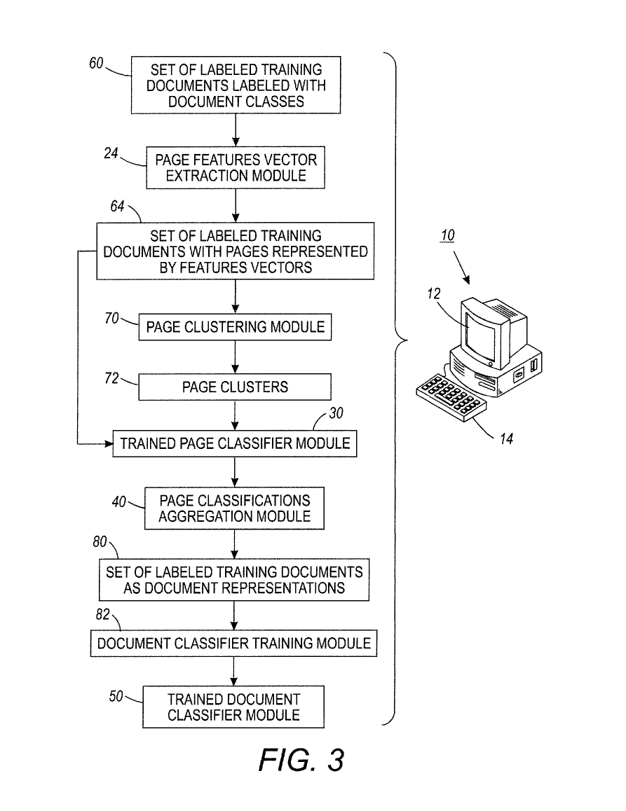

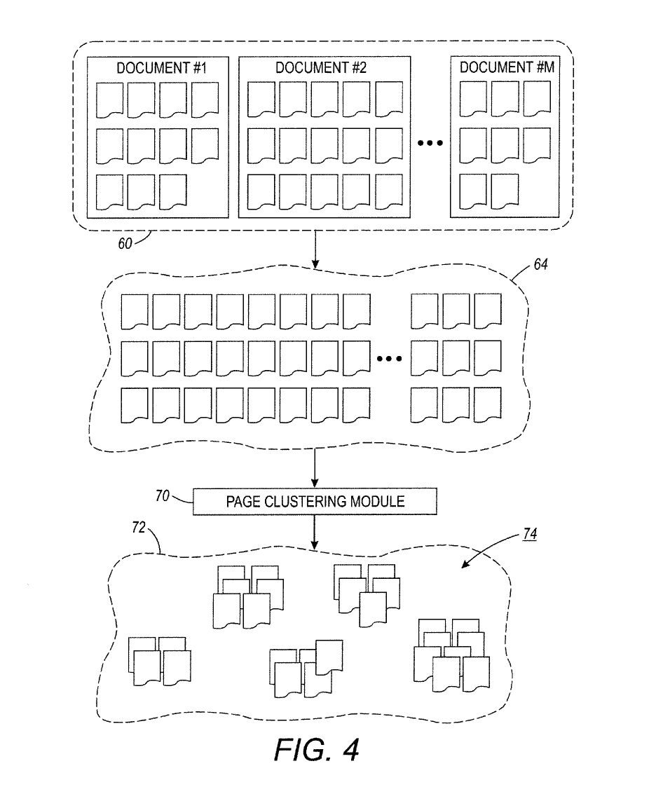

With reference to FIGS. 3 and 4, an illustrated approach for training the classifier modules 30, 50 employs a set of labeled training documents 60. The training documents of the labeled set 60 are manually labeled with document classes; however, the pages of the training documents are not labeled with page classes. Said another way, the set of labeled training documents 60 are labeled at the document level with document classifications, but are not labeled at the page level. In the previous example of 10,000 training documents with an average of ten pages per document, this reduces the number of manual classification operations to the number of documents, i.e. 10,000 manual classification operations. Moreover, the manual classification operations are all document classification operations, for which the user is likely to have a pre-defined or readily selectable set of document classes.

In order to accommodate the lack of page labels in the set of labeled training documents 60, an unsupervised training approach (also known as clustering) is used to train the page classifier module. The page features vector extraction module 24 (already described with reference to FIGS. 1 and 2) is applied to each page of the set of training documents 60 to generate a set of labeled training documents 64 with pages represented by features vectors. These pages are then clustered by a page clustering module 70 to generate page clusters 72 that identify groups of pages in the features vector space, as diagrammatically indicated in FIG. 4 which diagrammatically shows five page clusters in a features vector space 74. The clustering module 70 can employ substantially any clustering algorithm to generate the page clusters 72. By way of illustrative example, in some embodiments a K-means clustering algorithm is used, with a Euclidean distance for measuring distances between feature vectors and cluster centers in the features vector space.

The pages (represented by feature vectors) of the training documents can be partitioned in various ways in performing the clustering. Two illustrative approaches are described by way of example.

In one approach, all the pages of all the documents 64 are clustered together by the clustering module 70 in a single clustering operation. In the previous example of 10,000 training documents with an average of ten pages per document, the clustering module 70 clusters the entire set of ˜100,000 pages in a single clustering operation. This approach does not utilize the document classification labels in the page clustering operation.

In another approach, the pages are partitioned based on document classification of the source training document. That is, all pages of all training documents having a first document classification label are clustered together to generate a first set of clusters, all pages of all training documents having a second document classification label are clustered together to generate a second set of clusters, and so forth. The first, second, and further sets of clusters are then combined to form the final set of page clusters 72. Optionally, during the combining of the different sets of clusters generated for the different document classes, any similar clusters (e.g., clusters whose cluster centers are close together) may be merged. In this approach the document classification is used to perform an initial partitioning of the pages such that pages taken from documents of different document classification labels cannot be assigned to the same cluster (neglecting any post-clustering merger of similar clusters). Accordingly, this approach is sometimes referred to herein as “supervised learning” of the clusters, or as “supervised clustering”.

An advantage of supervised clustering is that it increases the likelihood that document representations for documents of different document classifications will be different. This is because the pages of a document of a given document classification are more likely to best match clusters generated from the pages of those training documents with the given document classification label. In other words, the supervised clustering approach tends to make the page clusters 72 more probative for distinguishing documents of different document classes.

The K-means clustering approach is a form of hard clustering, in which each page is assigned exclusively to one of the clusters. By way of an alternative illustrative example, in some embodiments a probabilistic clustering is employed in which pages are assigned in probabilistic fashion to one or more clusters. One suitable approach is to assume that the feature vectors representing the pages are drawn from a mixture model, such as a Gaussian mixture model (GMM). The K-means clustering is therefore replaced by the GMM learning using maximum likelihood estimation (MLE) (see, e.g., Bilmes, “A Gentle Tutorial of the EM Algorithm and its Application to Parameter Estimation for Gaussian Mixture and Hidden Markov Models”, TR-97-021, 1998). The computation of the soft assignments is based on the posterior probabilities of feature vectors to the components. Let C denote the number of components (i.e., clusters) in the GMM. Let wᵢ denote the mixture weight of the i^{th} component let pᵢ denote the distribution of the i^{th} component. Then the soft-assignment γᵢ(x) of feature vector x to the i^{th} component is given by Bayes' rule:

$${γ}_{i} ( x ) = \frac{{w}_{i} {p}_{i} ( x )}{{\sum }_{j = 1}^{C} {w}_{j} {p}_{j} ( x )} . \qquad ( 1 )$$

Such soft assignment can facilitate coping with page classifications that may have a fuzzy nature. Soft assignments also can alleviate a difficulty that can arise if the same page category corresponds to different clusters. This is an issue because two documents which have pages of the same page classification distribution may then be represented by different histograms. Said another way, this problem corresponds to having two or more different clusters representing the same actual (i.e., semantic or “real world”) page class. The likelihood of such a situation arising is enhanced in embodiments that employ supervised clustering, since if two different document classes have pages of the same page type they will be assigned to different page clusters (again, absent any post-clustering merger of clusters). The use of soft clustering combats this problem by allowing such pages to have fractional probability membership in each of two different clusters.

With continuing reference to FIGS. 3 and 4, the set of page clusters 72 is used to generate the trained page classifier module 30. In the case of K-means clustering or another hard clustering approach, the trained page classifier module 30 can employ a distance-based algorithm in which an input page (represented by its input page features vector) is assigned to the cluster whose cluster center is closest in the features vector space 74 to the position of the input page features vector in the features vector space 74. For soft assignment clustering using a GMM generative model, the trained page classifier module 30 suitably computes the page classification probabilities γᵢ(x), i=1, . . . , C for a page represented by features vector x using Equation (1) with trained values for the weights wᵢ, i=1, . . . , C, and for the parameters of the Gaussian components pᵢ(x) (e.g., Gaussian means μᵢ, i=1, . . . , C and covariance matrices, i=1, . . . , C).

With continuing reference to FIG. 3, once the trained page classifier module 30 is generated it can be used in the training of the document classifier module. Toward this end, the trained page classifier module 30 is applied to the pages 64 (again, represented by features vectors) of the training documents to generate page classifications for the pages of the training documents. (Note that this overcomes the initial issue that the set of labeled training documents 60 was labeled only at the document level, but not at the page level). The page classifications aggregation module 40 (already described with reference to FIGS. 1 and 2) is then applied to generate a set of labeled training documents 80 represented as document representations. A document classifier training module 82 is then applied to the labeled training set 80 to generate the trained document classifier module 50. The document classifier training module 82 can employ any suitable supervised learning algorithm. For example, in some embodiments the document classifier module 50 is embodied as a single multi-class classifier. In other embodiments, the document classifier module 50 is embodied as C_{D} binary classifiers (where C_{D} is the number of document classes in the set of document classes), optionally coupled with a selector that selects the document class having the highest corresponding binary classifier output.

As diagrammatically illustrated in FIGS. 1 and 3, the training system of FIG. 3 is optionally embodied by the same computer 10 (or other same digital processing device) as embodies the document classifier system of FIG. 1. Alternatively, different computers (or, more generally, different digital processing devices) can embody the systems of FIGS. 1 and 3, respectively.

The page classification operation performed by the trained page classifier module 30 is a lossy process insofar as the information contained in the features vector is reduced down to a class (e.g., cluster) selection or a set of class probabilities. This results in a “quantization” loss of information. To reduce or eliminate this effect, in some embodiments the page classifications 32 retain features vector positional information in the features vector space. By way of illustrative example, this can be done using a Fisher kernel. This illustrative approach utilizes the Fisher kernel framework set forth in Jaakkola et al., “Exploiting generative models in discriminative classifiers”, NIPS, 1999. Let X={xₜ, n=1, . . . , T} denote a document, where T is the number of pages and the t^{th} page is represented by a feature vector xₜ. It is assumed that there exists a probabilistic generation model of pages with distribution p whose parameters are collectively denoted. It follows that the document X can be described by the following gradient vector:

$$\frac{1}{T} {∇}_{λ} log ( p ( X \vert λ ) . \qquad ( 2 )$$

It can be shown (see, e.g., Perronnin et al., “Fisher kernels on visual vocabularies for image categorization”, CVPR, 2007) that in the case of a mixture model, the Fisher representation not only encodes the proportion of features assigned to each component (e.g., cluster) but also the location of features in the soft-regions defined by each component. In the case of a Gaussian mixture model (GMM), the parameters are λ={wᵢ, μᵢ, Σᵢ, i=1, . . . , C} where again C denotes the number of components (e.g., clusters) and wᵢ, μᵢ, Σᵢ respectively denote the weight, mean, and covariance matrix for the i^{th} Gaussian component of the GMM. Diagonal covariance matrices are assumed here, and σ denotes the standard deviation of the i^{th} Gaussian component. Then the partial derivatives of Equation (2) with respect to the mean and standard deviation are as follows (see Perronnin et al., “Fisher kernels on visual vocabularies for image categorization”, CVPR, 2007):

$$\begin{matrix}\frac{1}{T} \frac{\partial }{\partial {μ}_{i}} log ( p ( X \vert λ ) ) = \frac{1}{T} {\sum }_{t = 1}^{T} {γ}_{i} ( {x}_{t} ) ( \frac{{x}_{t} - {μ}_{i}}{{σ}_{i}^{2}} ) , \\ and & ( 3 ) \\ \frac{1}{T} \frac{\partial }{\partial {σ}_{i}} log ( p ( X \vert λ ) ) = \frac{1}{T} {\sum }_{t = 1}^{T} {γ}_{i} ( {x}_{t} ) ( \frac{{( {x}_{t} - {μ}_{i} )}^{2}}{{σ}_{i}^{3}} - \frac{1}{{σ}_{i}} ) . & ( 4 )\end{matrix}$$

Derivatives with respect to the weight vectors wᵢ are disregarded as they make little difference in practice.

The disclosed document classification techniques were implemented and tested. To provide a second technique for comparison, the following “Baseline” technique was used. First, page-level classifiers were learned using a training set with document-level classification labels but not page-level classification labels (that is, the same labeling as in the training set 60). The page-level classifiers were learned by the following operations: (i) extract page-level representations for each page of each training document (e.g., using the page features vector extraction module 24); (ii) propagate the document-level labels to the individual pages; and (iii) learn one page-level classifier per document category using the features of operation (i) and the labels of operation (ii). Sparse Logistic Regression (SLR) was used for the classification (iii) (see Krishnapuram et al., “Sparse multinomial logistic regression: Fast algorithms and generalization bounds”, IEEE PAMI, 27(6):957-68, 2005). Both linear and non-linear classification was tested and yielded similar results. Accordingly, results for the simpler linear classifier are reported herein. At runtime, to classify the input document the following operations were used: (iv) extract one feature vector per page; (v) compute one score per page per class; and (vi) aggregate the page-level scores into document-level scores for each document class. The scores computed at operation (v) are the class posteriors. As for operation (vi), different fusion schemes were tested and the best results were obtained with a simple summation of the per-page scores.

The actually performed tests are now summarized. A first set of tests were performed on a relatively smaller first dataset (“small dataset”) that contains 6 categories and includes 2060 documents and 10,097 pages. Half of the documents were used for training and half for testing. The accuracy was measured as the percentage of documents assigned to the correct category.

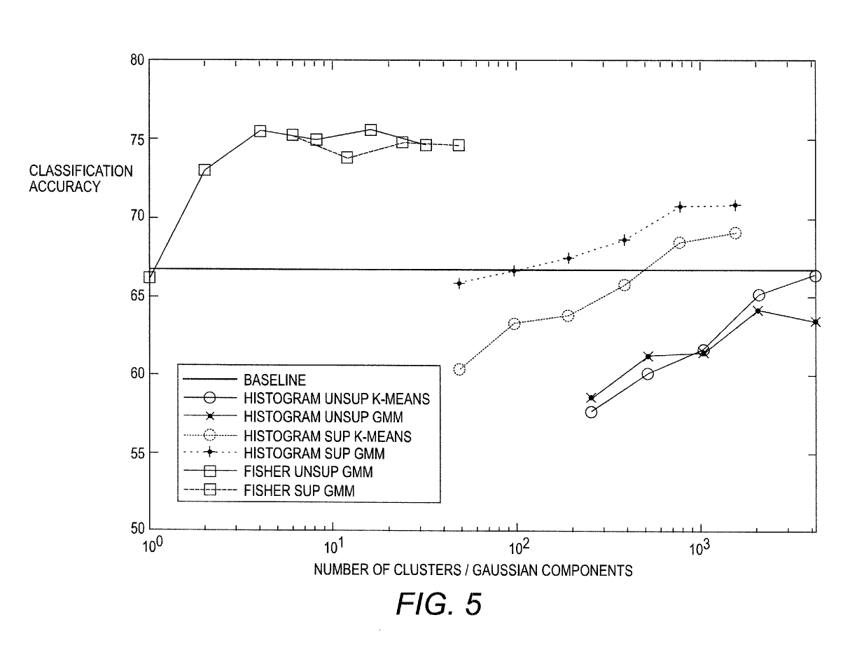

FIG. 5 shows results for the small dataset. In the legend: “Baseline” refers to the baseline technique used for comparison; “Histogram Unsup K-means” refers to unsupervised (hard) K-means clustering; “Histogram Unsup GMM” refers to unsupervised (soft) GMM-based clustering; “Histogram Sup K-means” refers to supervised (hard) K-means clustering (that is, supervised by partitioning the pages by document classification label and clustering each partition separately); “Histogram Sup GMM” refers to supervised (soft) GMM-based clustering; “Fisher Unsup GMM” refers to unsupervised (hard) GMM clustering using Fisher vector-based features vectors; and “Fisher Sup GMM” refers to supervised (soft) GMM-based clustering using Fisher vector-based features vectors. The GMM-based clustering employed learning by MLE.

The following observations can be made respective to the data shown in FIG. 5: (1) The unsupervised hard K-means clustering does not improve over the Baseline on the small dataset; (2) The supervised learning outperforms the unsupervised learning for histogram representations with both hard and soft assignment; (3) Using GMMs is advantageous over hard clustering when there are duplicate clusters as is the case in the supervised learning; (4) In the Fisher kernel case, there is no significant difference between supervised and unsupervised learning of the GMM; and (5) For the Fisher kernel, in the case where there is one Gaussian (unsupervised case), then it can be shown that the gradient with respect to the mean parameter encodes the average of the page feature vectors—this approach performs similarly to the baseline. The final observation is that performance is improved from 66.7% for the Baseline up to 74.9% for Fisher (unsupervised GMM with 4 Gaussian components).

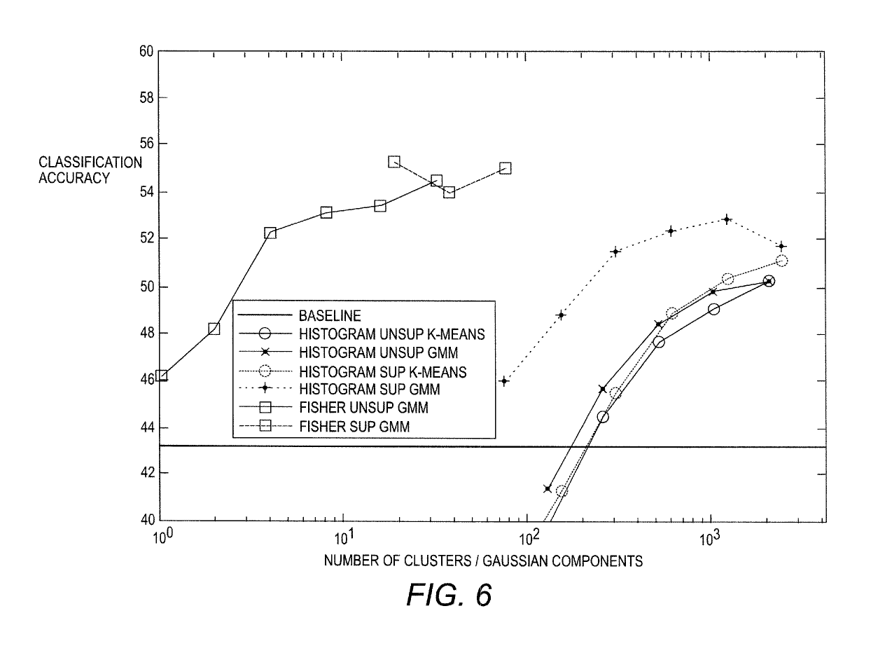

With reference to FIG. 6, a second set of tests were performed on a relatively larger second dataset (“large dataset”) that contains 19 categories and includes 19,178 documents and 57,530 pages. Half of the documents were used for training and half for testing. Again, the accuracy was measured as the percentage of documents assigned to the correct category. As seen in FIG. 6, all document classification approaches were superior to the Baseline.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
(i) classifying pages of an input document to generate page classifications;
(ii) aggregating the page classifications to generate an input document representation, the aggregating not being based on ordering of the pages; and
(iii) classifying the input document based on the input document representation;
wherein the operations (i), (ii), and (iii) are performed by a digital processor.

2. The method as set forth in claim 1, further comprising:
training a page classifier for use in the page classifying operation (i) based on pages of a set of labeled training documents having document classification labels.

3. The method as set forth in claim 2, wherein the pages of the set of labeled training documents are not labeled, and the page classifier training comprises:
clustering pages of the set of labeled training documents to generate page clusters; and
generating the page classifier based on the page clusters.

4. The method as set forth in claim 3, wherein the clustering comprises:
grouping pages of the set of labeled training documents into document classification groups based on the document classification labels; and
independently clustering the pages of each document classification group.

5. The method as set forth in claim 3, wherein the clustering comprises:
clustering pages of the set of labeled training documents using a probabilistic clustering method to generate page clusters with soft page assignments.

6. The method as set forth in claim 1, further comprising:
generating a set of labeled document representations by applying the page classifying operation (i) and aggregating operation (ii) to training documents of a set of labeled training documents that are labeled with document classification labels; and
training a document classifier for use in the input document classifying operation (iii) using the set of labeled document representations.

7. The method as set forth in claim 6, further comprising:
training a page classifier for use in the page classifying operation (i) based on pages of the set of labeled training documents.

8. The method as set forth in claim 7, wherein pages of the set of labeled training documents do not have page classification labels.

9. The method as set forth in claim 1, wherein the page classifying operation (i) comprises:
extracting features representations for the pages of the input document; and
classifying the pages based on the features representations for the pages.

10. The method as set forth in claim 9, wherein the features representations include features selected from one or more of a group consisting of visual features, text features, structural features.

11. The method as set forth in claim 9, wherein the page classifying operation (i) generates page classifications that retain features vector positional information in the features vector space.

12. The method as set forth in claim 11, wherein the page classifying operation (i) uses a Fisher kernel.

13. The method as set forth in claim 1, wherein the page classifying operation (i) assigns pages of the input document to page classes of a set of page classes, and the aggregating operation (ii) comprises:
generating a histogram or vector whose elements correspond to page classes of the set of classes.

14. The method as set forth in claim 13, wherein the page classifying operation (i) comprises hard page classification in which a page is assigned to a single page class of the set of page classes, and the aggregating operation (ii) comprises:
computing the elements of the histogram or vector as counts of pages of the input document assigned to corresponding page classes of the set of classes.

15. The method as set forth in claim 13, wherein the page classifying operation (i) comprises soft page classification in which a page is assigned probabilistic membership in one or more page classes of the set of page classes, and the aggregating operation (ii) comprises:
computing the elements of the histogram or vector as aggregations of probabilistic memberships of pages of the input document in corresponding page classes of the set of classes.

16. An apparatus comprising:
a digital processor configured to perform a method including:
(i) classifying pages of an input document to generate page classification, and
(ii) aggregating the page classifications to generate an input document representation.

17. The apparatus as set forth in claim 16, wherein the aggregating operation (ii) performed by the digital processor is not based on ordering of the pages.

18. The apparatus as set forth in claim 16, wherein the method performed by the digital processor further comprises:
training a page classifier for use in the page classifying operation (i) based on pages of a set of labeled training documents having document classification labels, the training including clustering pages of the set of labeled training documents to generate page clusters.

19. The apparatus set forth in claim 18, wherein the clustering comprises:
grouping pages of the set of labeled training documents into document classification groups based on the document classification labels; and
independently clustering the pages of each document classification group.

20. The apparatus as set forth in claim 16, wherein the page classifying operation (i) includes extracting features representations for the pages of the input document and classifying the pages based on the features representations for the pages, and the page classifying operation (i) generates page classifications that retain features vector positional information in the features vector space.

21. The apparatus as set forth in claim 16, wherein the page classifying operation (i) assigns pages of the input document to page classes of a set of page classes, and the aggregating operation (ii) comprises:
generating a histogram or vector whose elements correspond to page classes of the set of classes.

22. The apparatus as set forth in claim 16, wherein the method performed by the digital processor further comprises:
(iii) classifying the input document based on the input document representation.

23. The apparatus as set forth in claim 22, wherein the method performed by the digital processor further comprises:
generating a set of labeled document representations by applying the page classifying operation (i) and aggregating operation (ii) to training documents of the set of labeled training documents; and
training a document classifier for use in the input document classifying operation (iii) using the set of labeled document representations.

24. The apparatus as set forth in claim 22, further comprising:
a document routing module configured to route the input document based on an output of the classifying operation (iii).

25. A storage medium storing instructions that are executable by a digital processor to perform method operations including:
(i) classifying pages of an input document to generate page classification, and
(ii) aggregating the page classifications to generate an input document representation, the aggregating not based on ordering of the pages in the input document.

26. The storage medium as set forth in claim 25, wherein the stored instructions are executable by a digital processor to perform method operations further including:
(iii) classifying the input document based on the input document representation.

27. The storage medium as set forth in claim 25, wherein the stored instructions are executable by a digital processor to perform method operations further including at least one of:
retrieving a document similar to the input document from a database based on the input document representation, and
clustering a collection of input documents by repeating the operations (i) and (ii) for each input document of the collection of input documents and performing clustering of the input document representations.
